(19) United States
(12) Patent Application Publication
(10) Pub. No.: US 2011/0046941 A1
(43) Pub. Date: Feb. 24, 2011

(54) Advanced Natural Language Translation System

(76) Inventor: Johnson Manuel-Devados ("Johnson Smith"), Chennai (IN)

Correspondence Address: Johnson Manuel-Devadoss, 8383 El Mundo Street, #307, Houston, TX, 77054, US

(21) Appl. No.: 12/543,054

(22) Filed: Aug. 18, 2009

(51) Int. Cl. G06F 17/28; G10L 15/18

(52) U.S. Cl. 704/3; 704/257; 704/277; 704/E15.003

(57) ABSTRACT

The present invention is an Advanced Natural Language Translation System (ANLTS). It discloses a method to address the most common variation in the world, which is communication gap between people of different ethnicity. Typically, communication is said to be successful between two people if someone speaks and opponent party can understand. In other words the intended recipient's brain language area can comprehend the speech. The problem of not understanding the speech of others is the cause of language barriers. So, this invention discloses a method to solve the language barrier problem where it is capable of interpreting meaning of speech in one language to a language native to another—basically to a language the recipient brain can comprehend.

Imagine a world where we can communicate with our native language to everyone without the need of human translators, interpreters, hand-held device and language translation books. In order to facilitate language translation, this present invention recognizes the speech, collects the language comprehensive information from every recipient's brain language area within the audible range and sends it to voice processing center for analyzing. Then, it translates the collected speech to intended recipient(s) native language by using more than 6,700 language dictionaries database. The translated language is retransmitted in audible frequency to the language area of each recipient(s) brain.

### FIELD OF THE INVENTION

The present invention relates generally to a speech translating method, and more particularly, to automatically translate speech from one language to a language native to another which is understandable by the language (Wernicke/Broca) area of intended recipients' brain.

### BACKGROUND OF THE INVENTION

Languages are mankind's principle tools for interacting expressing ideas, emotions, knowledge, memories and values. Languages are also primary vehicles of cultural expressions and intangible cultural heritage, essential to the identity of individuals and groups. Safeguarding endangered languages is a crucial task in maintaining cultural diversity worldwide. According to researchers more than 6,700 languages are spoken in 228 countries. For example, in India more than 250 languages are used for speech. People like to speak in their native language and prefer to communicate with others in their native language. This makes it difficult for people to travel to foreign states or countries as they need to learn the foreign language.

In field of entertainment, if someone wants to watch a foreign movie/performance, they experience problems in clearly understanding the event. Obviously, lots of electronic translator equipments are available in the world, but it only supports popularly spoken languages.

Language barriers and misunderstandings can get in the way of effective communication and create complications in the workplace, including problems with safety. A recent Business Journal article on the rising number of foreign national workers in Charlotte-Mecklenburg's construction industry pointed out—those workers who speak little or no English are at much greater risk of having an accident on the job because of not having a full grasp of safety standards.

Approximately 22% of the Sheraton Corporation's workforce is Hispanic, primarily Mexicans. Language is the main barrier here. To help its employers deal with the language challenge, the company has bilingual employees to serve as translators and mentors. In addition, all printed material is provided in both the essential languages Spanish and English. Another example is Woonsocket Spinning Company—Woonsocket is one of the few remaining woolen mills in the United States. 70% of their employees are foreign-born. Overcoming language barriers is the greatest challenge for both workers and the employer. To help with this, the company hires interpreters or has other employees who speak the language help the non-English speaking employees, particularly during orientation and training. Studies like this suggest companies spend a lot of time and effort to overcome language barriers among employees.

Patients from under developing countries seeking medical care always need to be accompanied with human translators to explain their medical problems and also to understand physician's advice. Results from a survey of leading physician organizations, medical groups and other health care associations in California suggest that nearly half (48%) of the 293 respondents knew of an instance in which a patient's limited English proficiency impacted his or her quality of care. The three biggest complaints were difficulty of history talking, wrong diagnosis and a general frustration with the lack of nuance in physician-patient communication with patients who have Limited English Proficiency (LEP).

In the ever growing IT industry people from various nationalities collaborate in meetings and conferences. Due to language barrier they cannot communicate freely resulting in business people investing lot of time and money learning new languages.

Even in marketing, due to language as barrier quality retail and consumer product owners struggle to market their products on international market.

There are number of language translation systems available in the world designed and developed to translate an inputted language to another language. All these methods/systems require a device to capture the voice and deliver. Such systems are known in the prior patents as disclosed in U.S. Pat. No 4,882,681 to Brotz et al for Remote Language Translating Device. This prior patent disposes the translation of conversation between the users by transmitting/receiving speech using external hardware device. But people would not prefer to carry or even remember to carry the hardware device all the time. Also the disadvantage of such system is that it can be used to convert only a certain number of languages which are pre-programmed on the device.

U.S. Pat. No. 6,161,082 to Goldberg et al for Network based language translation system performs a similar task. It disposes a network based language translation system—basically has a translation software installed on the network. It proves that software over network can do speech translation, but user still has to set their language preferences. More than 67% of world's population do not or have limited computer knowledge, so they cannot set their language preferences and operate high-tech gadgets. Another recent patent is U.S. Pat. No US 2009/0157410 to Donohoe et al for speech translating system. This recent patent discloses a system for translating speech from one language to a language selected from a set of languages. It can be applicable only for limited amount of users but more than 6,700 languages are being used by people to express their thoughts around the world.

Another patent is U.S. Pat. No. 4,641,264 to Nitta et al for a Method of Automatic Translation between Natural Languages—this discloses a system for the translation of entire sentences. Then again it also requires an input and output device to capture and deliver the speech. It is not capable to determine the recipients' understandable language. We have to manually set the targeted language or select from pre-defined languages (as target) in the device.

Therefore to overcome all the above language barriers, there is a need for a system to perform automatic translation of speech wherein when one speaks in a native language others are able to comprehend in their own native languages without interpreters, hand-held device and language translation books.

### SUMMARY OF THE INVENTION

Speech translation is basically converting to a language that the language area of recipient human brain can understand. Recipient(s) may not be able to comprehend the speech because their brain language area is not tuned to understand the spoken language. In medical terms, it is called “Wernicke's Aphasia”.

The language area of human brain is called “Wernicke” which is nothing but a neuron in human brain capable to interpret words that we hear or read. Wernicke then relays this information via a dense bundle of fibers to Broca's area that generates words that we speak in response. Wernicke/Broca together has all the language comprehensive information needed for understanding speech.

This invention disposes a process where humans are not going be aware a translation is happening in the background. They will be able to speak their own native language but others surrounding them can automatically understand the speech in their own native language. This system therefore bridges all communication gaps among people.

The main object of the present invention is to provide an Advanced Natural Language Translation System that is capable of providing a translation of speech in one language to a language native to another which is understandable by the language (Wernicke's/Broca's) area of the recipients' brain. The present invention thereby replaces interpreters, hand-held device and language translation books.

The present Advanced Natural Language Translation System (ANLTS) invention has two main logical processing units—the Intelligent Natural Language Program (INLP) and the Voice Processing Center. The human ear can hear frequencies at ˜70 decibels. When we talk our thoughts are converted into voice signals and transmitted into the surrounding regions. This system employs a data broadcasting technique to broadcast the Intelligent Natural Language Program (INLP) over a wide area using radio waves.

The Intelligent Natural Language Program (INLP) is like a Pico-planner program on the network that looks for human voice signals. It further comprises of an Intelligent Speech Recognition Algorithm and the Language Area Acquisition Algorithm. The Intelligent Speech Recognition Algorithm provides phoneme-level sequence to the parser where each has a probability of being correct. The Language Area Acquisition Algorithm collects information from the language area of the human brain and transmits it to Voice Processing Center. Radio waves are used to transfer signals to and from the Voice Processing Center.

Voice Processing Center receives the signals having language comprehensive information and several competitive phoneme or word hypotheses each of which are assigned the probability of being correct. Voice Processing Center operates using a Language Area Inference Engine. The Language Area Inference Engine is an artificial intelligence program that tries to derive native language information from a knowledge base. Language Area Inference Engine is considered to be a special case of reasoning engines, capable of employing both induction and deduction methods of reasoning.

This invention facilitates tourism. People are now free to travel to any corner of the world. They don't have to carry any hand-held devices. This invention facilitates people to enjoy foreign movie/performances without need of friends as human translators or sophisticated translation devices. Patients can be provided with the right care that they require. This invention also eliminates all miscommunications and reduces death totality in industries. Employers can hire people from any ethnicity as language will no longer be a barrier.

This invention also facilitates businessmen from any country to expose their quality products worldwide within a less budget. Everyone can continue to effectively communicate in their own native language in meetings and conferences while employers can save money on language translation books.

All these put together with other aspects of the present invention, along with the various features that describe the present invention, especially those pointed out in the claims section form a part of the present invention. To gain more knowledge of the present invention understanding of the drawings attached and the detailed description is highly essential.

### BRIEF DESCRIPTION OF THE DRAWINGS

FIG. 1.a illustrates two people of the system speaking in their native language using Advanced Natural Language Translation System.

FIG. 1.b illustrates a group of five people of the system exchanging conversation in their native language using Advanced Natural Language Translation System.

FIG. 1.c illustrates a group of business people of the system exchanging their business conversation in their native language using Advanced Natural Language Translation System

FIG. 1.d illustrates spokesman of the system addressing a crowd in his native language using Advanced Natural Language Translation System.

FIG. 2 illustrates the detailed operation of this invention.

FIG. 3 is a partially schematic, isometric illustration of a human brain illustrating areas associated with language comprehension

FIG. 4 illustrates a processing flow of this invention

### DETAILED DESCRIPTION OF THE INVENTION

Reference will now be made in detail to the preferred embodiments of the present invention, examples of which are illustrated in the accompanying drawings, wherein like reference numerals refer to like elements throughout.

Communication is said to be effective between two people, if one speaks and opponent party can understand. In other words the intended recipients' brain language area can comprehend the words/sentence/speech. The present invention basically does that—interpreting meaning of word(s) in a language understandable by Wernicke's of intended recipient brain.

In human beings, it is the left hemisphere that usually contains the specialized language areas. While this holds true for 97% of right-handed people, about 19% of left-handed people have their language areas in the right hemisphere and as many as 68% of them have some language abilities in both the left and the right hemisphere. Both the two hemispheres are thought to contribute to the processing and understanding of language: the left hemisphere processes the linguistic of prosody, while the right hemisphere processes the emotions conveyed by prosody.

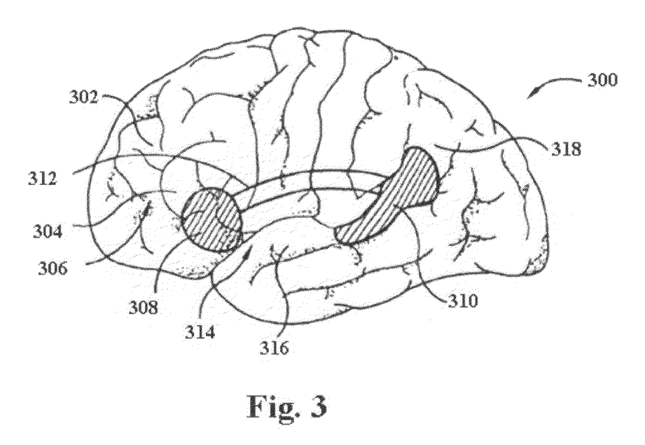

FIG. 3 is an isometric, left side view of the brain 300. The targeted language areas of the brain 300 can include Broca's area 308 and/or Wernicke's area 310. Sections of the brain 300 anterior to, posterior to, or between these areas can be targeted in addition to Broca's area 308 and Wernicke's area 310. For example, the targeted areas can include the middle frontal gyrus 302, the inferior frontal gyrus 304 and/or the inferior frontal lobe 306 anterior to Broca's area 308. The other areas targeted for stimulation can include the superior temporal lobe 314, the superior temporal gyrus 316, and/or the association fibers of the arcuate fasciculus 312, the inferior parietal lobe 318 and/or other structures, including the supramarginal gyrus, angular gyrus, retrosplenial cortex and/or the retrosplenial cuneus of the brain 300.

There are four distinct cortical language-related areas in the left hemisphere. These are: (1) a lateral and ventral temporal lobe region that includes superior temporal sulcus (STS) 316, middle temporal gyrus (MTG), parts of the inferior temporal gyrus (ITG) and fusiform and parahippocampal gyri; (2) a prefrontal region that included much of the inferior and superior frontal gyri, rostral and caudal aspects of the middle frontal gyrus, and a portion of the anterior cingulate; (3) angular gyrus; and (4) a perisplenial region including posterior cingulate, ventromedial precuneus, and cingulate isthmus. These regions were clearly distinct from auditory, premotor, supplementary motor area (SMA), and supramarginal gyrus areas that had been bilaterally activated by the tone task. The other large region activated by the semantic task is the right posterior cerebellum.

The first language area within the left hemisphere is called Broca's area 308. The Broca's area 308 doesn't just handle getting language out in a motor sense it is more generally involved in the ability to deal with grammar itself, at least the more complex aspects of grammar. The second language area is called Wernicke's area 310. Wernicke's Aphasia is not only about speech comprehension People with Wernicke's Aphasia also having difficulty in naming things. They often respond with words that sound similar, or the names of related things, as if they are having a very hard time with their mental “dictionaries.” For example, hearing the difference between “bad” and “bed” is easy for native English speakers. The Dutch language however, makes no difference between these vowels, and therefore the Dutch have difficulties hearing the difference between them. This problem is exactly what patients with Wernicke's aphasia have in their own language: they can't isolate significant sound characteristics and classify them into known meaningful systems.

By analyzing data from numerous brain-imaging experiments, researchers have now distinguished three sub-areas within Wernicke's area 310. The first sub-area responds to spoken words (including the individual's own) and other sounds. The second sub-area responds only to words spoken by someone else but is also activated when the individual recalls a list of words. The third sub-area is more closely associated with producing speech than with perceiving it. All of these findings are still compatible, however, the general role of Wernicke's area 310, relates to the representation of phonetic sequences, regardless of whether the individual hears them, generates them, or recalls them from memory.

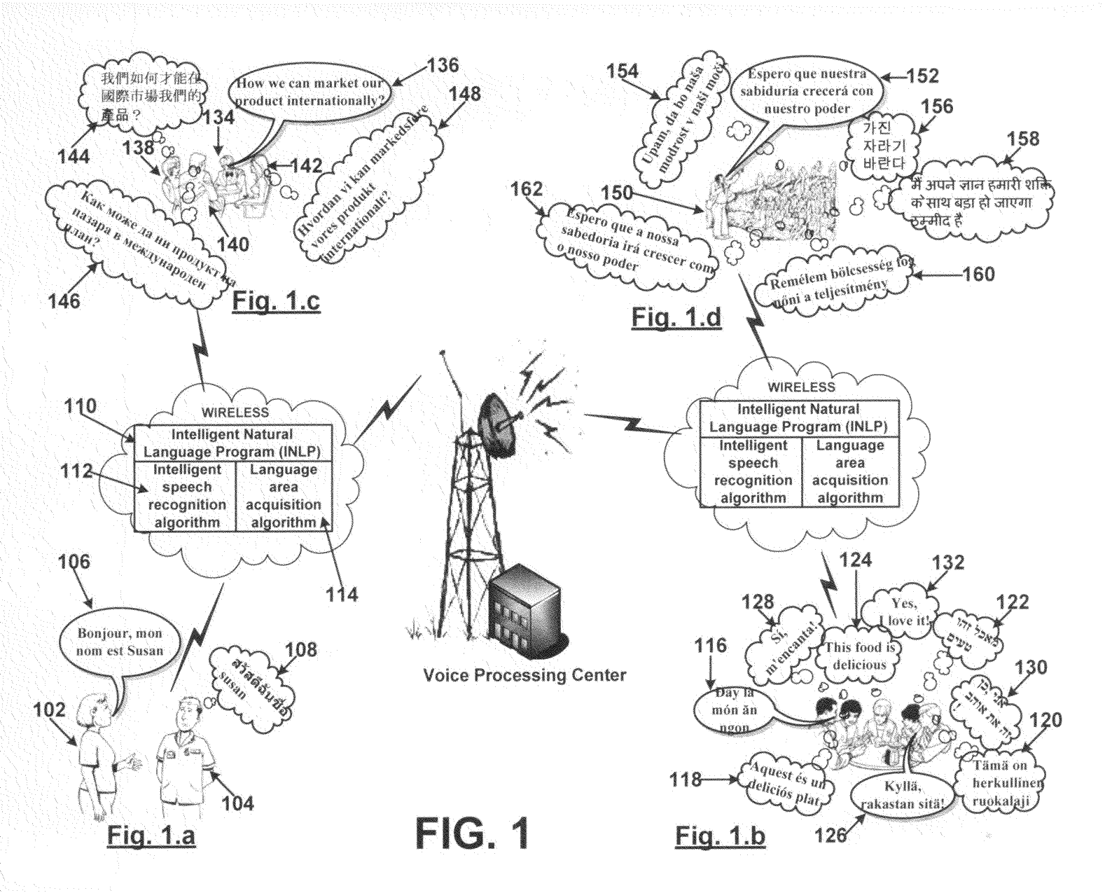

FIG. 1 illustrates the broad structure of this present invention. FIG. 1.a shows a woman 102 saying her name in her native language French—“Bonjour, mon nom est Susan” 106. The present invention employs a data broadcasting technique to broadcast the Intelligent Natural Language Program (INLP) 110 over a wide area using radio waves. Intelligent Natural Language Program 110 is a Pico-program which is advanced version of natural language processing programs i.e., ELIZA, SHRDLU, A.L.I.C.E, written in special kind of Pico-Planner programming language. The Intelligent Natural Language Program 110 has two Algorithms:—Intelligent Speech Recognition Algorithm 112 and Language Area Acquisition Algorithm 114. Intelligent Speech Recognition Algorithm 112 captures and improves the recognition rate of the spoken dialog in three ways. First, generate phoneme sequence from recognized voice pitches. This phoneme sequence contains substitution, insertion and deletion of phonemes, as compared to a correct transcription which contains only expected phonemes. Second, activate a hypothesis as to the correct phoneme sequence from noisy phoneme sequence by filtering out false first choices of the hypotheses and selecting grammatically and semantically plausible best hypotheses. Third, provide a phoneme and word hypotheses to the parser which consist of several competitive phoneme or word hypotheses each of which are assigned the probability of being correct. The Intelligent Speech Recognition Algorithm captures the spoken sentence of woman—“Bonjour, mon nom est Susan” 106 and provides phoneme-level sequence i.e., phoneme and word hypotheses.

Intelligent Natural Language Program 110 initiates the Language Area Acquisition Algorithm 114 to gather the language comprehensive information from the single listener man 104 who is in the audible range of the woman's 102 voice. The Language Area Acquisition Algorithm 114 is capable of collecting the language area comprehensive information like Language Comprehension, Semantic Processing, Language Recognition, and Language Interpretation from Wernicke's area 310 and Broca's area 308. It will collect the information from Wernicke's area 310 of single listener man's brain namely Superior Temporal Sulcus and Middle Temporal Gyrus, Inferior Temporal Gyrus, Fusiform Gyrus, Angular Gyrus, Inferior Frontal Gyrus, Rostral and Caudal Middle Frontal Gyrus, Superior Frontal Gyrus, Anterior Cingulate, and Perisplenial Cortex/Precuneus. The language comprehensive, phonemes and word hypotheses are collected and sent to Voice Processing Center over datacasting network.

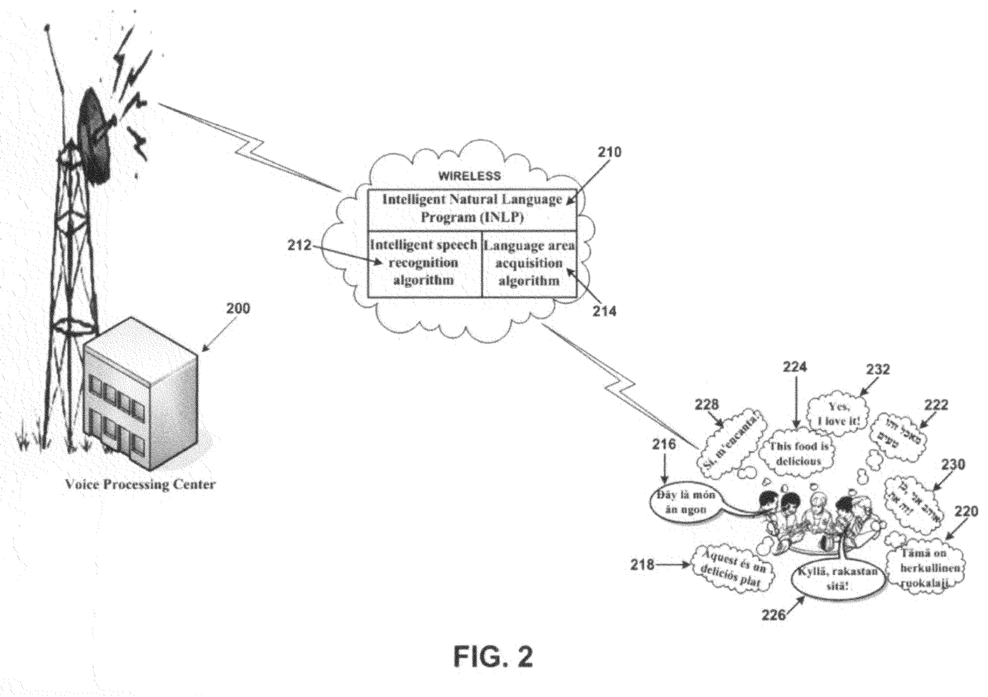

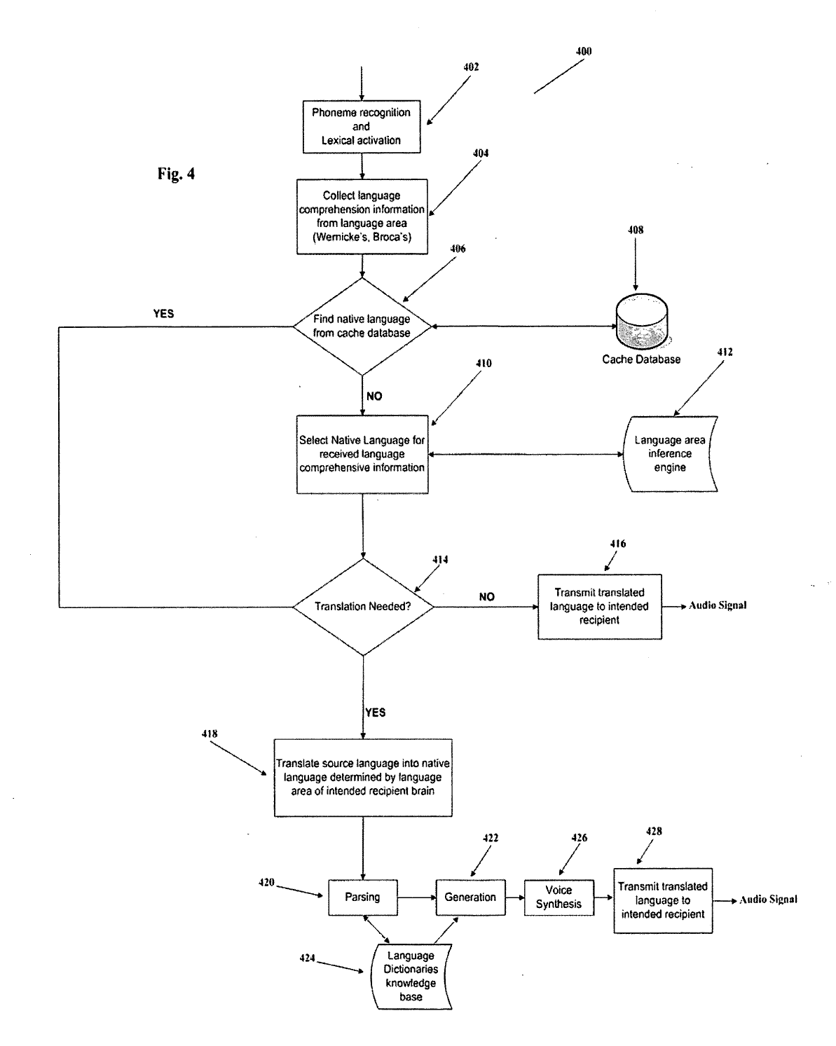

In FIG. 2 Voice Processing Center 210 receives the signals having language comprehensive information and phoneme-level sequence—each of which is assigned the probability of being correct. The language comprehensive information is compared with cache database. In FIG. 4 Cache database 408 is a collection of native language data. Retrieval of original native language is expensive owing to longer access time; the cache is a cost effective way to store the original native language or other computed languages. It acts like a temporary storage area where frequently accessed native language data can be stored for rapid access. Once the data is stored in the cache, it can be used in the future by accessing the cached copy rather than re-fetching or re-computing the original native language data. Cache database 408 is thus an effective approach to achieve high scalability and performance.

Voice Processing Center 210 is operated by a Language Area Inference Engine 412 which includes a knowledge base of all possible language area information. It is an artificial intelligence program that tries to derive native language information from a knowledge base for woman's 104 and man's 102 language comprehensive information. It tries to derive reasoning from the knowledge base. The separation of Language Area Inference Engine 412 as a distinct software component stems from the typical speech translating system architecture. This architecture relies on a data store, or working memory, serving as a global database representing facts or assertions about the Wernicke's 310 and Broca's 308 areas of human brain; on a set of rules which constitute the program, stored in a rule memory of production memory; and on an inference engine, required to execute the language comprehensive rules. The Language Area Inference Engine 412 must determine which language comprehensive rules are relevant to a given language comprehensive data store configuration and choose which one(s) to apply. This control strategy is used to select native languages.

The Language Area Inference Engine 412 can be described as a form of finite state machine with a cycle consisting of three action states: match, select, and execute language comprehensive rules.

In the first state, match language comprehensive rules, the Language Area Inference Engine 412 finds all of the language comprehensive rules that are satisfied by the current contents of the data store. When language comprehensive rules are in the typical condition-action form, the next step is to test the conditions against the working memory. The language comprehensive rule matching are all candidates for execution: they are collectively referred to as the conflict set. Note that the same language comprehensive rule may appear several times in the conflict set if it matches different subsets of data items. The pair of a language comprehensive rule and a subset of matching data items are called an instantiation of the language comprehensive rule.

The Language Area Inference Engine 412 (In FIG. 4) then passes along the conflict set to the second state, select language comprehensive rules. In this state, the Language Area Inference Engine 412 (In FIG. 4) applies LEX strategy to determine which language comprehensive rules will actually be executed. The selection strategy can be hard-coded into the engine or may be specified as part of the model. The LEX strategy orders instantiations on the basis of recency of the time tags attached to their language comprehensive data items. Instantiations with language comprehensive data items having recently matched language comprehensive rules in previous cycles are considered with higher priority. Within this ordering, instantiations are further sorted on the complexity of the conditions in the rule.

Finally the selected language comprehensive instantiations are passed over to the third state, execute language comprehensive rules. The Language Area Inference Engine 412 (In FIG. 4) executes or fires the selected language comprehensive rules, with the language comprehensive instantiation's data items as parameters. Usually the actions in the right-hand side of a language comprehensive rule change the data store, but they may also trigger further processing outside of the Language Area Inference Engine 412 (In FIG. 4). Since the data store is usually updated by firing rules, a different set of rules will match during the next cycle after these actions are performed. The Language Area Inference Engine 412 then cycle back to the first state and are ready to start over again and it stops either on a quiescent state of the data store when no rules match the data.

The selected native languages are then compared 414 (In FIG. 4) with the source native language. If both native language information are same then translation will not take place otherwise a translation will take place. The accurate translation of input speech is done by sophisticated parsing 420 (In FIG. 4) and generation 422 (In FIG. 4). The translation module has parsing 420 (In FIG. 4) and generation 422 (In FIG. 4) which is capable of interpreting the woman's 102 spoken dialog. The parsing 420 (In FIG. 4) module performs the process of prediction including complete semantic interpretations, constraint checks, and ambiguity resolution and discourse interpretations. This system uses the fuse constraint-based and case-based approaches to perform syntactic/semantic and discourse interpretations. The parser 420 (In FIG. 4) handles multiple hypotheses in parallel rather than a single word sequence.

A generation 422 (In FIG. 4) module is designed to generate the appropriate spoken sentences with correct articulation control. It generates the appropriate spoken sentences using language dictionaries knowledge base. The Language Dictionaries Knowledge Base 424 (In FIG. 4) is used for keeping track of more than 6,700 language discourse and world knowledge established during the conversation, and is continuously up-dated during processing. Thus, the appropriate sentence has been generated for woman's spoken sentence to man's 104 (In FIG. 1.a) native language—as shown in 108 (In FIG. 1.a) where man's brain language area (i.e., Wernicke's 310/Broca's 308 area) can comprehended.

This system performs real-time translations, which is far better performance than text-based machine translation systems. Unlike traditional methods of machine translation in which a generation 422 (In FIG. 4) process is invoked after parsing 420 (In FIG. 4) is completed; this system concurrently executes the generation 422 (In FIG. 4) process during parsing 420 (In FIG. 4). It employs a parallel incremental generation scheme, where the generation process and the parsing process run almost concurrently. This enables the system to generate a part of the woman's 102 (In FIG. 1.a) vocal expression during the parsing of the rest of the woman's 102 (In FIG. 1.a) vocal expression. Thus this system stimulates a live feeling—where one speaks and instantaneously the listeners can comprehend the speech in their native languages.

The advanced natural language system also handles two-way conversations. This system provides the bi-directional translation with an ability to understand interaction at the discourse knowledge level, predict possible next vocal expression, understand what particular pronouns refer to, and also provides high-level constraints for the generation of contextually appropriate sentences involving various context-dependent phenomena.

FIG. 1.b illustrates the conversation between friends who are all foreign-language speaking people. Vietnamese speaking person is saying “This food is delicious” in his native language such as shown in 116, this sentence is comprehended as shown in 118 by the Cantalan speaking person, as shown in 120 by Finnish speaking person, and as shown in 122 by Hebrew speaking person and also as shown in 124 by English speaking person. The Finnish speaking person acknowledges back to them in his native as shown in 126. Others comprehend the Finnish sentence as shown in 128, as shown in 130, as shown in 132 respectively using Advanced Native Language Translation System.

Similarly, FIG. 1.c illustrates a business conversation. A boss 134 is asking as shown in FIG. 1. 136 to his subordinates. His subordinates are a Chinese woman 138, Bulgarian man 140, and Danish woman 142. The boss's 134 spoken dialog is comprehended as shown in 144 by Chinese speaking woman, as shown in 146 by Bulgarian speaking man, and as shown in 148 Danish speaking woman using Advanced Native Language Translation System.

FIG. 1.d illustrates the spokesman 150 is giving a speech in his native language Spanish as shown in 152 to a crowd. There are Slovenian, Korean, Hindi, Hungarian, and Portuguese speaking people in the crowd. So, the spokesman's Spanish speech is automatically comprehended by Slovenian speaking person as shown in 154, by Korean speaking person as shown in 156, by Hindi speaking person as shown in 158, by Hungarian speaking person as shown in 160, and by Portuguese speaking person as shown in 162 using Advanced Native Language Translation System.

As described above, the present invention discloses a system for translating a speech in one language to a language native to the intended recipient(s). Accordingly, the present invention discloses a system of comprehending native languages without the use of any hand-held translators. This invention employs a system where there will no longer be a need to learn new language. Effective communication is now feasible between people speaking different languages. This system explores the capabilities of the human brain and utilizes the language information of the brain and performs the automatic translation in the background. It should be noted that with all the reading of language area of the human brain—the human brain will not be affected or caused any harm during this process.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application. Although the present invention has been described with reference to particular embodiments, it will be apparent to those skilled in the art that variations and modifications can be substituted without departing from the principles and spirit of the invention.

### REFERENCES

“How the brain learns to read” By David A. Sousa

“Natural Language Generation in Artificial Intelligence and Computational Linguistics” By Cécile L. Paris, William R. Swartout, William C. Mann

“Artifidal intelligence methods and applications” By Nikolaos G. Bourbakis

T. Morimoto et al., “Spoken Language Translation,” Proc. Info Japan, Tokyo, 1990.

K. Kita, T. Kawabata, and H. Saito, “HMM Continuous Speech Recognition using Predictive L R Parsing,” Proc. IEEE Int'l Conf. Acoustics, Speech, and Signal Processing, 1989.

“Natural language processing technologies in artificial intelligence” By Klaus K. Obermeier

“Advances in artificial intelligence: natural language and knowledge-based” By Martin Charles Golumbic

I claim:

1. A method to translate native language spoken from one person into a language that is understood by language area of brain of one or plurality of listeners without use of intermediate device.

2. A method of claim 1 comprises of an Intelligent Natural Language Program and a Voice Processing Center.

3. A method of claim 2, wherein said Intelligent Natural Language Program is a Pico-Planner Program broadcast over air and looks for an acoustic waveform in the air and collecting language comprehensive information from the language areas of the brain of one or plurality of intended recipient,
wherein said acoustic waveform is the voice spoken by a human being;
wherein said intended recipient who is in the audible range of an acoustic waveform;
wherein said language area are Wernicke's area, Broca's area and frontal lobes of the human brain.
wherein said frontal lobe is the part of each hemisphere of the brain located behind the forehead that serves to regulate and mediate the higher intellectual functions. The said frontal lobes have intricate connections to other areas of the brain.
wherein said Wernicke's area is an area in the posterior temporal lobe of the left hemisphere of the brain involved in the recognition of spoken words;
wherein said Broca's area is a region in the left frontal lobe of the brain associated with speech that controls movements of the tongue, lips, and vocal cords.

4. The Intelligent Natural Language Algorithm of claim 3 further comprises of Intelligent Speech Recognition Algorithm and Language Area Acquisition Algorithm.

5. The Intelligent Natural Language Algorithm of claim 4, wherein said Intelligent Speech Recognition Algorithm is an smart speech recognition algorithm that identifies an acoustic waveform consisting of alternating high and low air pressure travelling through the air and recognize the phoneme-level sequences from an acoustic waveform and synthesizes the acoustic waveform eliminating noise and transmitting only the required voice signals.

6. The Intelligent Natural Language Algorithm of claim 4, wherein said Language Area Acquisition Algorithm is an electromagnetic radiation broadcast directed towards the plurality of intended recipient head to provide a rapid analysis of the language area of the brain,
wherein said language area of the human brain are Left and Right hemispheres and frontal lobes;
wherein said rapid analysis is the language associated data signals about Language Comprehension, Semantic Processing, Language Recognition, and Language Interpretation information.

7. A method of claim 2, wherein said Voice Processing Center to identify the native language from received language comprehensive information and translate the voice signals into other languages which is native to plurality of said intended recipient.

8. The Voice Processing Center of claim 7 further comprises of Language Area Inference Engine, Language Dictionaries Knowledge Base.

9. The Voice Processing Center of claim 8, wherein said Language Area Inference Engine is an artificial intelligence program that derives the native language information from a knowledge base.

10. The Language Area Inference Engine of claim 9, wherein said knowledge base is an exhaustive, comprehensive, obsessively massive list of samples of language area information called a knowledge base. This information is collected from experimental data of brain's said language areas and information from neurologists.

11. The Language Area Inference Engine of claim 9, wherein said artificial intelligence program performs matching, selecting and executing possible set of language comprehensive rules and arrives with the native language for one or plurality of the listener.

12. The Language Area Inference Engine of claim 9, wherein said derive native language information is parsing, generating and synthesizing the final translated voice using the Language Dictionaries Knowledge Base.

13. The Voice Processing Center of claim 8, wherein said Language Dictionaries Knowledge Base is also an exhaustive, comprehensive, obsessively massive dictionaries of all words from each of the 6,700 languages spoken around the world. This said Language Dictionaries Knowledge Base is used for translating the spoken word to any of the other 6,700 languages.

14. A method of claim 1 must at least comprise of the:
system having an Input human voice spoken in a native language
system having a listener individual or a group of individuals unable to understand the native language.
